(19) United States
(12) Patent Application Publication
(10) Pub. No.: US 2005/0074014 A1
(43) Pub. Date: Apr. 7, 2005

(54) Network brokering system

(76) Inventors: Chunghwa Heman Rao, Taipei (TW); Sheng-Hsuan Liao, Taipei (TW); Chia-Jung Liang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/674,555

(22) Filed: Oct. 1, 2003

(51) Int. Cl. H04L 12/56

(52) U.S. Cl. 370/395.53

(57) ABSTRACT

A network and network services brokering system between network companies and mobile virtual network operators which provides efficient billing systems in order to provide improved network services to subscribers. The network brokering system comprises a virtual network operator who provides network services to subscribers, a network company who provides usage of their physical networks to the virtual network operator, and a network broker who interfaces between the network company and virtual network operator. Additionally, the network broker provides interfacing between virtual network operators and independent content providers. The network broker further comprises a real-time call control and common service platform for real-time controlling of call, billing, and payment information. Using the real-time call control and common service platform allows complex billing such as partial pre-paid and partial post-paid payment schemes. Through the services of the network broker, the virtual network operator has usage of the network company's networks.

### BACKGROUND OF THE INVENTION

1. Field of the Invention

The present invention relates to communication network systems. More specifically, the present invention discloses a network brokering system for wireless communication networks comprising a network broker interfacing between a network company and a virtual network operator.

2. Description of the Prior Art

At present, mobile telephone network companies provide basic communication services to mobile phone users. Some of these services are the ability to make and receive telephone calls and access networks such as a wireless application protocol (WAP) network.

Two types of mobile phone users utilize these services. One type is a pre-paid subscriber and another type is a post-paid subscriber.

The pre-paid subscriber pays for all services in advance. This is commonly achieved by the user purchasing a calling card for a certain value and recharging their pre-paid account for the value of the calling card. Pre-paid subscribers find that this system provides an increased level of financial control over their telephone usage fees. However, a disadvantage of the pre-paid system is that the account value can be depleted at inopportune times, thus leaving the user without telephone services until they purchase another card and recharge their account.

The post-paid subscriber pays for all services on a periodic basis, such as once a month. The post-paid subscriber receives a bill detailing the usage charges and service fees, and pays the network company according to the amount due. The post-paid system is convenient since telephone services are always available if the account is paid up to date. However, if the post-paid subscriber does not closely monitor their usage, a relatively large cost could be charged to their account.

Additionally, as the number and sophistication of subscribers grows, demand increases for more specialized or unique services. Since the traditional telephone company is not up to meeting the increasing demand for modem services, other organizations need to get involved in providing specialized services. However, since the cost of establishing a network and providing network services is very high, these new organizations must find available networks to use for their services.

In addition, complex billing structures and methods are required to control systems with an increasing number of modem services. No longer do the pre-paid and post-paid subscriber models fulfill the new requirements.

Also, in order to control the billing for advanced services, new systems must be created. However, to date no effective and efficient system exists for performing these tasks.

Therefore, there is a need for an effective system for providing network company networks and services and an efficient billing system to mobile virtual network operators in order to provide improved communication services and billing for network companies, mobile virtual network operators, and subscribers.

### SUMMARY OF THE INVENTION

To achieve these and other advantages and in order to overcome the disadvantages of the conventional method in accordance with the purpose of the invention as embodied and broadly described herein, the present invention provides a network and network services brokering system between network companies and mobile virtual network operators and provides efficient billing systems in order to provide improved network services to subscribers.

The network brokering system comprises a mobile virtual network operator, a network company, and a network broker. The network company is an established company with physical networks such as a telephone network. The mobile virtual network operator doesn't have their own network. In order for the mobile virtual network operator to utilize the networks of the network company, a network broker provides an interface. The network broker negotiates with the network company on behalf of the mobile virtual network operator for usage of the network. The network broker also provides a network company interface to interface between the network company and the network broker. The network broker also provides a mobile virtual network operator interface to interface between the network broker and the mobile virtual network operator.

In advance systems, the network broker also provides an interface between independent content providers and the mobile virtual network operator. In this way, the mobile virtual network operator is able to provide special content to their subscribers, such as multimedia, movies, music, games, etc., that they don't create themselves.

Additionally, the network broker provides a real-time call control and common service platform for real-time control of billing and calling. When a subscriber places a call, the real-time call control and common service platform begin processing before the call is connected. In this way, complex billing schemes can be easily implemented as all calls are controlled in real time, regardless if the subscriber is a pre-paid or a post-paid subscriber. As a result, a subscriber can be partially pre-paid and partially post-paid depending on the service provided.

The network broker is capable of providing multiple networks from a plurality of network companies and various content from a plurality of content providers to a plurality of mobile virtual network operators. The network broker provides these services while also providing real-time call control and a common service platform.

An advantage of the present invention is the network broker is able to combine the total usage of the networks or content by the combination of the participating mobile virtual network operators in order to negotiate the best pricing and rates from the network companies and content providers.

Furthermore, the network broker can switch between networks of different network companies when desired. For example, if better rates are available in certain instances, the network broker can switch to the network offering better value.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating a network brokering system comprising a network company, a network broker, and a mobile virtual network operator according to an embodiment of the present invention;

FIG. 2 is a block diagram illustrating a network brokering system comprising a network company, a network broker, and a plurality of mobile virtual network operators according to an embodiment of the present invention;

FIG. 3 is a block diagram illustrating a network brokering system comprising a plurality of network companies, a network broker, and a mobile virtual network operator according to an embodiment of the present invention;

FIG. 4 is a block diagram illustrating a network brokering system comprising a plurality of network companies, a network broker, and a plurality of mobile virtual network operators according to an embodiment of the present invention; and

FIG. 5 is a block diagram illustrating a network brokering system comprising a plurality of network companies, a network broker, a plurality of mobile virtual network operators, and a plurality of content providers according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

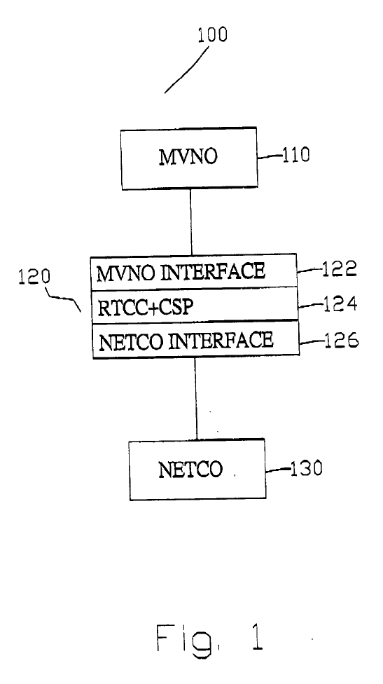

Refer to FIG. 1, which is a block diagram illustrating a network brokering system comprising a network company, a network broker, and a mobile virtual network operator according to an embodiment of the present invention.

The network brokering system 100 comprises a mobile virtual network operator (MVNO) 110, a network company (NETCO) 130, and a network broker 120. The network broker 120 further comprises an MVNO interface 122 for interfacing with the MVNO 110, a NETCO interface 126 for interfacing with the NETCO 130, and a real time call control (RTCC) and common service platform (CSP) 124.

The NETCO 130 provides a physical network structure for the network brokering system 100. The MVNO 110 provides a virtual network and services to subscribers. The MVNO 110 also provides billing services and customer care services to their subscribers. The network broker 120 provides mediatory services to interface between the NETCO 130 and the MVNO 110.

In order to provide usage of the physical networks of the NETCO 130 to the MVNO 110, the network broker 120 comprises two interface layers; a NETCO interface 126 and a MVNO interface 122. The NETCO interface 126 comprises a circuit switch (CS) and a packet switch (PS). The MVNO interface 122 comprises CS control, CSP application program interface (API), and a billing API.

The RTCC and CSP 124 provide real time processing of billing. When a subscriber places a call, the RTCC and CSP 124 begin processing before the call is connected. In this way, complex billing schemes can be easily implemented as all calls are controlled in real time, regardless if the subscriber is a pre-paid or post-paid subscriber. As a result, a subscriber can be partially pre-paid and partially post-paid depending on the service provided.

For example, a subscriber elects to have basic voice telephone calls billed as post-paid for convenience and WAP or Internet access pre-paid for financial control. With previous systems, this type of complex billing is not possible. However, using the RTCC and CSP of the present invention, these more advanced payment systems are realized.

The RTCC and CSP 124 utilize two types of switches; a circuit switch (CS) and a packet switch (PS). The signal through the CS is for the call data and the signal through the PS is only the call information. No voice data of the call goes through the PS. The PS provides the proper information to the RTCC and CSP 124 so the RTCC and CSP 124 can begin processing such as verifying, approving, and beginning billing procedures.

When the call is finished, the RTCC and CSP 124 recognize that the call has terminated and finalizes processing.

Since the RTCC and CSP is a real time process, the account status is immediately known and can be appropriately controlled, updated, or modified.

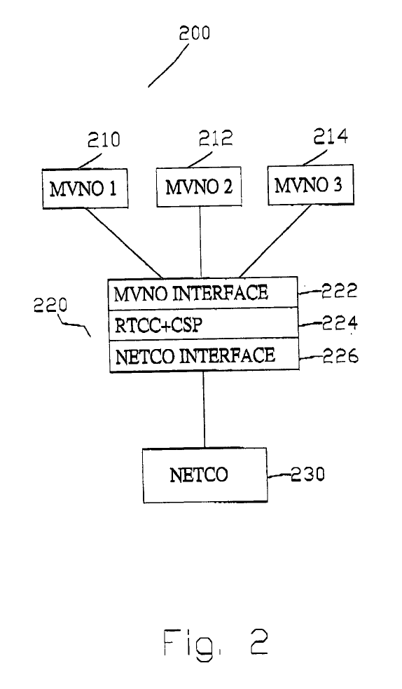

Refer to FIG. 2, which is a block diagram illustrating a network brokering system comprising a network company, a network broker, and a plurality of mobile virtual network operators according to an embodiment of the present invention.

The network brokering system 200 shown in FIG. 2 comprises a NETCO 230, a network broker 220, and a plurality of MVNOs; MVNO1 210, MVNO2 212, and MVNO3 214.

Obviously it is advantageous for the network broker 220 to cooperate with a multiple number of MVNOs, not only to increase revenue, but also to negotiate better rates from the NETCO 230 based on a combined total usage of the plurality of MVNOs. Whereas the system illustrated in FIG. 1 comprises a single MVNO, the network brokering system 200 in FIG. 2 comprises a plurality of MVNOs. Therefore, when negotiating with the NETCO 230, the network broker 220 can combine the volume of MVNO1 210, MVNO2 212, and MVNO3 214. Since the total volume is much greater than the individual volumes, the network broker is able to get better rates and pricing.

This savings allows the network broker to offer a better deal to the participating MVNOs, making the MvNOs more profitable. The increased volume also increases the revenue of the NETCO 230 and the network broker 220. Utilizing the network brokering system 200 of the present invention allows all participants to be more profitable.

In order to interface with MVNO1 210, MVNO2 212, and MVNO3 214, the network broker provides an MVNO interface 222 and a NETCO interface 226 to interface with the NETCO 230.

The MVNO interface 222 comprises an advanced billing API and CSP API in order to support the plurality of MVNOs.

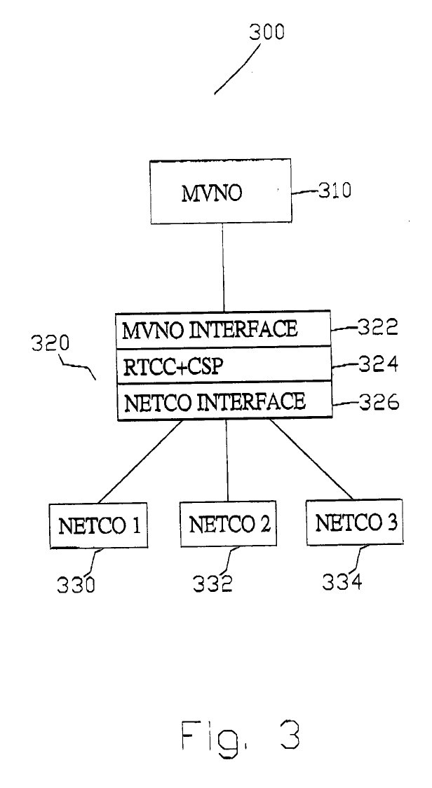

Refer to FIG. 3, which is a block diagram illustrating a network brokering system comprising a plurality of network companies, a network broker, and a mobile virtual network operator according to an embodiment of the present invention.

The network brokering system 300 as shown in FIG. 3 comprises an MVNO 310, a network broker 320, and a plurality of NETCOs; NETCO1 330, NETCO2 332, and NETCO3 334.

Similar to FIGS. 1 and 2, the network broker 320 comprises a MVNO interface 322, a NETCO interface 326, and an RTCC and CSP 324. However, since the network broker 320 interfaces with a multiple number of NETCOs, the NETCO interface 326 is more advanced.

An advantage of the network brokering system 300 as illustrated in FIG. 3 is that the network broker 320 negotiates with different NETCOs in order to provide the best rates, pricing, and service to the MVNO 310. When appropriate, the network broker 320 can negotiate with competing NETCOs for usage of their networks. This works as an incentive for the NETCOs to offer lower pricing or better service.

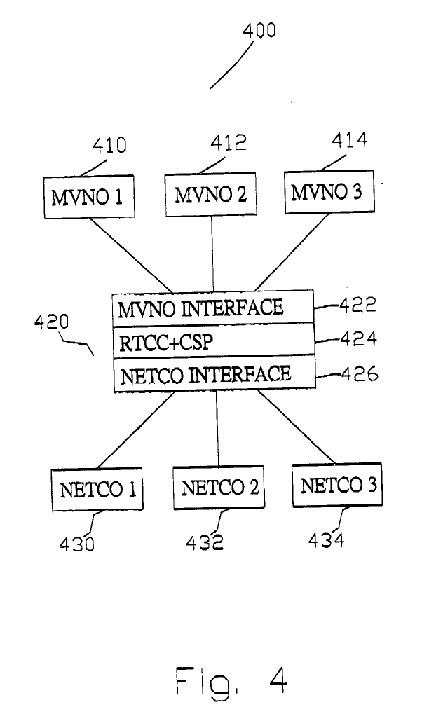

Refer to FIG. 4, which is a block diagram illustrating a network brokering system comprising a plurality of network companies, a network broker, and a plurality of mobile virtual network operators according to an embodiment of the present invention.

The network brokering system 400 as illustrated in FIG. 4 enjoys the combined benefits and advantages of the systems shown in FIGS. 2 and 3. The network brokering system 400 comprises a plurality of MVNOs; MVNO1 410, MVNO2 412, and MVNO3 414 and a plurality of NETCOs; NETCO1 430, NETCO2 432, and NETCO3 434.

The network broker 420 can combine the volume of MVNO1 410, MVNO2 412, and MVNO3 414. Since the total volume is much greater than the individual volumes, the network broker 420 is able to get better rates and pricing. This savings allows the network broker 420 to offer a better deal to the participating MVNOs, making the MVNOs more profitable. Additionally, the network broker 420 negotiates with different NETCOs in order to provide the best rates, pricing, and service to the MVNOs. When appropriate, the network broker 420 can negotiate with competing NETCOs for usage of their networks. This works as an incentive for the NETCOs to offer lower pricing or better service.

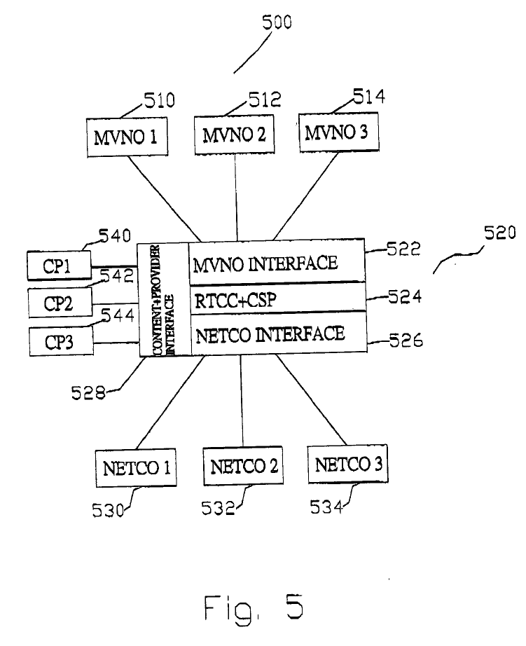

Refer to FIG. 5, which is a block diagram illustrating a network brokering system comprising a plurality of network companies, a network broker, a plurality of mobile virtual network operators, and a plurality of content providers according to an embodiment of the present invention.

The network brokering system 500 illustrated in FIG. 5 comprises a plurality of MVNOs; MVNO1 510, MVNO2 512, and MVNO3 514, a plurality of NETCOs; NETCO1 530, NETCO2 532, and NETCO3 534, a plurality of content providers (CP); CP1 540, CP2 542, and CP3 544, and a network broker 520.

The network broker 520 comprises an RTCC and CSP 524, an MVNO interface 522, a NETCO interface 526, and a CP interface 528.

In certain situations, an MVNO does not create or provide some content itself. In order for the MVNO to offer enhanced content to its subscribers, content providers supply the content. This content is, for example, games, applications, movies, music, etc. The network broker 520 negotiates with content providers on behalf of the MVNO in order to obtain content.

Because a multiple number of MVNOs may wish to offer content from a single content provider, the network broker 520 is able to combine the total volume or usage of the multiple number of MVNOs using the content. This allows the network broker 520 to negotiate better rates from the content provider.

As an example of an implementation of an embodiment of the present invention, the following is given.

A network broker approaches a well-know chain store and discusses the advantages of the chain store becoming a network operator. While the chain store had previously considered the opportunity, they were hesitant due to the large expense of creating their own network. However, the network broker quickly pointed out the option of quickly becoming a virtual network operator relying on the physical networks of an established network company. Additionally, the chain store was concerned about creating content for subscribers. Since the network broker had several qualified content providers available, this no longer became a concern. Once the network broker established the basic requirements for the store, the network broker negotiated pricing and rates from several network companies and several content providers. Because the network broker already had agreements with other virtual network operators, the network broker combined the total usage volume of the participating virtual network operators with the expected usage of the new virtual network operator. As a result, the network broker was able to negotiate a very good agreement with the network companies and content providers. Also, since more than one of the virtual network operators used the same content from the same content provider, better pricing was received from the content provider. Furthermore, since one network company had better daytime rates and another had better nighttime rates, the network broker chose to use both of the network companies but switch between the two according to the best value. Utilizing all of these advantages, the network broker was able to negotiate good network services and content at reasonable rates for the virtual network operators.

After the chain store established themselves as a virtual network operator using their well-know name, subscribers began purchasing network services from them. When a subscriber made a telephone call, the real-time call control and common service platform immediately began processing. The real-time call control and common service platform verified and authorized the subscriber's account and billing information and the call was connected. During the call, the appropriate billing information was monitored. When the call was terminated, the billing information was updated and provided to the virtual network operator. Also, appropriate network information was gathered and updated in order to control payment for network usage of the network company's network.

Also, if the call was a call to access multimedia content from the content provider, billing, payment and usage information was monitored and controlled by the network broker.

Since the virtual network operator was a chain store, they were able to offer special services and incentives to their subscribers. Such incentives were the ability to earn points based on usage by the subscribers. In turn, the subscribers were able to cash in their points for goods available from the chain store that weren't directly associated with network services. These types of incentives are not available when subscribing directly to a network company whose only product is network services.

As described in this example, the complex billing and payment schemes require advanced systems in order to effectively and efficiently control billing and payment. Utilizing the real-time call control of the system of the present invention, the network broker is able to provide up to date billing and payment services for the virtual network operators, the network companies, and the content providers. This is only one example of an implementation scenario utilizing the present invention. Other implementations are possible while enjoying the benefits and advantages of the network brokering system of the present invention.

It is understood that while the various figures show three MVNOs, three NETCOs, or three CPs, any number of MVNOs, NETCOs, or CPs is possible. In embodiments of the present invention, the number of participating MVNOs, NETCOs, or CPs is greater than three. Also, a combination of various numbers of each is provided. For example, in some embodiments of the present invention, there are ten MVNOs, fifteen CPs, and two NETCOs. It is understood that various combinations of multiple participants are possible.

Additionally, in embodiments of the present invention, the network broker is a NETCO, a branch of a NETCO, a NETCO affiliate, an MVNO, a branch of an MVNO, an MVNO affiliate, a CP, a branch of a CP, or a CP affiliate. Although aligned with another participant in the system, the network broker continues to provide the valuable services with the benefits and advantages as detailed above.

For example, in order to increase revenue from increased network traffic, a NETCO creates a network brokering service as an extension of itself to attract various MVNOs or an MVNO creates a network brokering service and provides network brokering services to other MVNOs.

Also, the network is preferably a network for mobile telephone usage. However, utilizing the method for brokering networks of the present invention, the network can also be a telephone, wireless, cable, communication, satellite, or computer network or a combination of these networks.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

1. A network system comprising:
at least one virtual network operator for providing virtual networks and network services to subscribers;
at least one network company for providing usage of a network to the at least one virtual network operator; and
a network broker for providing an interface between the at least one network company and the at least one virtual network operator.

2. The network system of claim 1, the network broker comprising;
a virtual network operator interface for interfacing the at least one virtual network operator and the network broker;
a real-time call control and common service platform for providing real-time billing; and
a network company interface for interfacing the at least one network company and the network broker.

3. The network system of claim 2, the virtual network operator interface comprising;
a circuit switch control;
a common service platform application program interface; and
a billing application program interface.

4. The network system of claim 2, the network company interface comprising;
a circuit switch for providing a call data signal; and
a packet switch for providing a call information signal.

5. The network system of claim 2, wherein the real-time call control and common service platform begin processing when a subscriber initiates a call and before the call is connected.

6. The network system of claim 1, wherein the network comprises a telephone, wireless, cable, communication, satellite, or computer network or a combination of these networks.

7. The network system of claim 2, further comprising;
at least one content provider for providing content for the virtual network operator.

8. The network system of claim 8, the network broker further comprising a content provider interface for interfacing the at least one content provider and the network broker.

9. A network system comprising:
a virtual network operator for providing network services to subscribers;
a network company for providing usage of a network to the virtual network operator; and
a network broker for interfacing the network company and the virtual network operator; the network broker further comprising;
a virtual network operator interface for interfacing the virtual network operator and the network broker;
a real-time call control and common service platform for providing real-time billing services; and
a network company interface for interfacing the network company and the network broker.

10. The network system of claim 9, the virtual network operator interface comprising;
a circuit switch control;
a common service platform application program interface; and
a billing application program interface.

11. The network system of claim 9, the network company interface comprising;
a circuit switch for providing a call data signal; and
a packet switch for providing a call information signal.

12. The network system of claim 9, wherein the real-time call control and common service platform begin processing when a subscriber initiates a call and before the call is connected.

13. The network system of claim 9, wherein the network comprises a telephone, wireless, cable, communication, satellite, or computer network or a combination of these networks.

14. The network system of claim 9, further comprising;
a content provider for providing content for the virtual network operator.

15. The network system of claim 14, the network broker further comprising a content provider interface for interfacing the content provider and the network broker.

16. A network system comprising:
at least one virtual network operator for providing network services to subscribers;
at least one network company for providing usage of a network to the at least one virtual network operator; and
a network broker for interfacing the at least one network company and the at least one virtual network operator; the network broker further comprising;
a virtual network operator interface for interfacing the at least one virtual network operator and the network broker, the virtual network operator interface comprising;
a circuit switch control;
a common service platform application program interface; and
a billing application program interface;
a real-time call control and common service platform for providing real-time billing services; and
a network company interface for interfacing the at least one network company and the network broker, the network company interface comprising;
a circuit switch for providing a call data signal; and
a packet switch for providing a call information signal.

17. The network system of claim 16, wherein the real-time call control and common service platform begin processing when a subscriber initiates a call and before the call is connected.

18. The network system of claim 16, wherein the network comprises a telephone, wireless, cable, communication, satellite, or computer network or a combination of these networks.

19. The network system of claim 16, further comprising;
at least one content provider for providing content for the at least one virtual network operator.

20. The network system of claim 19, the network broker further comprising a content provider interface for interfacing the at least one content provider and the network broker.
